(19) United States
(12) Patent Application Publication
(10) Pub. No.: US 2022/0400448 A1
(43) Pub. Date: Dec. 15, 2022

(54) TERMINAL AND COMMUNICATION METHOD

(71) Applicant: NTT DOCOMO, INC., Tokyo (JP)

(72) Inventor: Hiromasa Umeda, Tokyo (JP)

(73) Assignee: NTT DOCOMO, INC., Tokyo (JP)

(21) Appl. No.: 17/628,426

(22) PCT Filed: Aug. 9, 2019
(86) PCT No.: PCT/JP2019/031776

§ 371 Date: Jan. 19, 2022

(51) Int. Cl. H04W 52/30

(52) U.S. Cl. CPC H04W 52/30; H04W 88/06

(57) ABSTRACT

A terminal includes a control unit using, in DC using first and second RATs, a first power class (PC) if a duty cycle is not greater than a threshold, the duty cycle obtained by adding a value obtained by multiplying: a first RAT duty cycle; a value obtained by dividing a maximum transmit power allowed for a network of the first RAT by a maximum transmit power for the DC corresponding to the first PC; and a ratio indicating a degree of influence of the first RAT over the second RAT, to a value obtained by multiplying: a second RAT duty cycle; and a value obtained by dividing a maximum transmit power allowed for a network of the second RAT by a maximum transmit power for the DC corresponding to the first PC, and a transmission unit performing uplink transmission to which the first PC is applied.

### TECHNICAL FIELD

The present invention relates to a terminal and a communication method in a radio communication system.

### BACKGROUND ART

In NR (New Radio) (also referred to as “5G”) as a successor system of LTE (Long Term Evolution), techniques for providing greater network capacity, higher data transmission speeds, reduced latency, simultaneous connections of more terminals, lower cost, and improved power efficiency are being discussed (for example, non-patent document 1).

In an LTE system or an NR system, a network provides queries to a UE (User Equipment) to acquire information associated with UE's radio access capability (for example, non-patent document 2). For example, the UE's radio access capability may include a supported maximum data rate, a total buffer size for layer 2, a supported band combination, a parameter associated with a PDCP (Packet Data Convergence Protocol) layer, a parameter associated with an RLC (Radio Link Control) layer, a parameter associated with a MAC (Medium Access Control) layer, a power class for defining the maximum transmit power as a parameter associated with a physical layer and so on (for example, non-patent document 3).

### PRIOR ART DOCUMENT

### Non-Patent Document

[Non-Patent Document 1] 3GPP TS 38.300 V15.5.0 (2019-03)
[Non-Patent Document 2] 3GPP TS 38.311 V15.5.1 (2019-04)
[Non-Patent Document 3] 3GPP TS 38.101 V15.5.0 (2019-03)

### SUMMARY OF INVENTION

### Problem to be Solved by the Invention

In the NR system, the power class of a larger maximum transmit power than conventional ones is defined in different bands and different RAT (Radio Access Technologies). This power class is defined as PowerClass2 and allows for 26 dBm transmission. A terminal supporting the PC2 as its UE capability is referred to as a HighPowerUE (referred to as a “HPUE” hereinafter). The HPUE reports a duty cycle, where transmission at the maximum transmit power 26 dBm is enabled, as the UE capability to a network in consideration of problems such as a SAR (Specific Absorption Rate) or heating in the terminal.

However, if satisfaction of the stipulation associated with the maximum transmit power is attempted by controlling the duty cycle, particularly in dual connectivity or carrier aggregation applied communication, such transmit power control schemes for allocating the power to bands or RATs (Radio Access Technologies) are unclear.

In light of the above aspect, the present invention aims to appropriately control the transmit power determined by the duty cycle in a radio communication system.

### Means for Solving the Problem

According to a technique disclosed herein, there is provided a terminal, comprising: a control unit that uses, in dual connectivity using a first RAT (Radio Access Technology) and a second RAT, a first power class in a case where a duty cycle is less than or equal to a threshold, the duty cycle obtained by adding a value obtained by multiplying: a duty cycle for the first RAT; a value obtained by dividing a maximum transmit power allowed for a network of the first RAT by a maximum transmit power for the dual connectivity corresponding to the first power class; and a ratio indicative of a degree of influence of the first RAT over the second RAT as a reference, to a value obtained by multiplying: a duty cycle for the second RAT; and a value obtained by dividing a maximum transmit power allowed for a network of the second RAT by a maximum transmit power for the dual connectivity corresponding to the first power class; and a transmission unit that performs uplink transmission to which the first power class is applied.

### Advantage of the Invention

According to the disclosed technique, the transmit power controlled by the duty cycle in a radio communication system can be appropriately configured.

### BRIEF DESCRIPTION OF DRAWINGS

FIG. 1 is a diagram illustrating an arrangement example of a network architecture according to an embodiment of the present invention;

FIG. 2 is a diagram illustrating an arrangement example of a radio communication system according to an embodiment of the present invention;

FIG. 3 is a sequence diagram illustrating a terminal capability report example according to an embodiment of the present invention;

FIG. 4 is a flowchart illustrating a configuration example of an applied power class according to an embodiment of the present invention;

FIG. 5 is a diagram illustrating a specification change example (1) for configuration of a power class according to an embodiment of the present invention;

FIG. 6 is a diagram illustrating a specification change example (2) for configuration of a power class according to an embodiment of the present invention;

FIG. 7 is a diagram illustrating a specification change example (3) for configuration of a power class according to an embodiment of the present invention;

FIG. 8 is a diagram illustrating a specification change example (4) for configuration of a power class according to an embodiment of the present invention;

FIG. 9 is a diagram illustrating a specification change example (5) for configuration of a power class according to an embodiment of the present invention;

FIG. 10 is a diagram illustrating a specification change example (6) for configuration of a power class according to an embodiment of the present invention;

FIG. 11 is a diagram illustrating a functional arrangement example of a base station 10 according to an embodiment of the present invention;

FIG. 12 is a diagram illustrating a functional arrangement example of a terminal 20 according to an embodiment of the present invention; and

FIG. 13 is a diagram illustrating a hardware arrangement example of the base station 10 or the terminal 20 according to an embodiment of the present invention.

### EMBODIMENTS OF THE INVENTION

Hereinafter, embodiments of the present invention will be described with reference to the drawings. The embodiments described below are merely examples, and embodiments to which the present invention is applied are not limited to the following embodiments.

In operations of a radio communication system according to an embodiment of the present invention, conventional techniques are used as needed. Note that the conventional techniques may include current LTE, for example, but are not limited to current LTE. Also, unless specifically stated otherwise, it should be appreciated that the terminology “LTE” used herein has a broader meaning including LTE-Advanced and its subsequent schemes (e.g., NR).

Also, in embodiments of the present invention as described below, terminologies “SS (Synchronization Signal)”, “PSS (Primary SS)”, “SSS (Secondary SS)”, “PBCH (Physical Broadcast Channel)”, “PRACH (Physical Random Access Channel)”, “PDCCH (Physical Downlink Control Channel)”, “PUCCH (Physical Uplink Control Channel), “PDCCH (Physical Downlink Shared Channel)”, “PUCCH (Physical Uplink Control Channel), “PUSCH (Physical Uplink Shared Channel) or the like used in the current LTE are used. This is due to convenience of recitations, and a signal, a function or the like similar to them may be referred to as other wordings. Also, the above terminologies correspond to “NR-SS”, “NR-PSS”, “NR-SSS”, “NR-PBCH”, “NR-PRACH”, “NR-PDCCH”, “NR-PDCCH”, “NR-PUCCH” and “NR-PUSCH”, respectively, in the NR. Note that even if the signals are used in the NR, they may not be explicitly described as “NR-”.

Also, in embodiments of the present invention, duplexing schemes may include Time Division Duplexing (TDD), Frequency Division Duplexing (FDD) or other schemes (e.g., flexible duplexing or the like).

Also, in embodiments of the present invention, “configuring” a radio parameter or the like may mean that a predetermined value is preconfigured or that a radio parameter indicated from the base station 10 or the terminal 20 is configured.

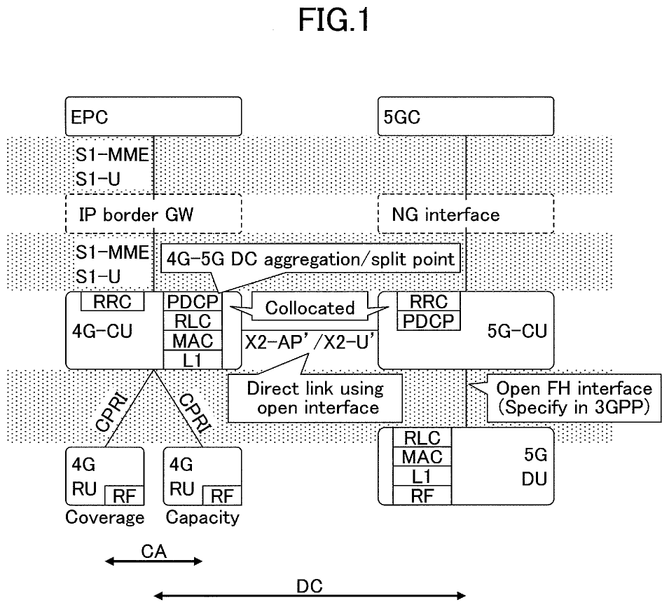

FIG. 1 is a diagram illustrating an arrangement example of a network architecture. As illustrated in FIG. 1, a radio network architecture according to an embodiment of the present invention includes a 4G-CU, a 4G-RU (Remote Unit, a remote radio station), an EPC (Evolved Packet Core) and so on in the side of LTE-Advanced. The radio network architecture according to the embodiment of the present invention includes a 5G-CU, a 5G-DU and so on in the side of 5G.

As illustrated in FIG. 1, the 4G-CU includes layers up to an RRC (Radio Resource Control), a PDCP (Packet Data Convergence Protocol), an RLC (Radio Link Control), a MAC (Medium Access Control) and an L1 (Layer 1, PHY layer or Physical layer) and is coupled to the 4G-RU via a CPRI (Common Public Radio Interface). A network node including the 4G-CU and the 4G-RU is referred to as an eNB.

On the other hand, in the 5G side, as illustrated in FIG. 1, the 5G-CU includes an RRC layer and is coupled to a 5G-DU via a FH (Fronthaul) interface and to a 5GC (5G Core Network) via an NG interface. Also, the 5G-CU is coupled to the 4G-CU via an X2 interface. The PDCP layer in the 4G-CU becomes a coupling or decoupling point for 4G-5G DC (Dual Connectivity), that is, EN-DC (E-UTRA-NR Dual Connectivity). A network node including the 5G-CU and the 5G-DU is referred to as a gNB. Also, the 5G-CU and the 5G-DU may be referred to as a gNB-CU and a gNB-DU, respectively.

Also, as illustrated in FIG. 1, CA (Carrier Aggregation) is performed among 4G-RUs, and DC is performed between the 4G-RU and the 5G-DU. Although not illustrated, a UE (User Equipment) is wirelessly connected to the 4G-RU or the 5G-DU via their RFs to transmit and receive packets.

Note that FIG. 1 corresponds to the radio network architecture for the LTE-NR DC, that is, for the EN-DC (E-UTRA-NR Dual Connectivity). However, if the 4G-CU is divided into CU-DU or is operated as NR standalone, the same radio network architecture may be used. If the 4G-CU is divided into the CU-DU, functionalities associated with the RRC layer and the PDCP layer may move to the 4G-CU, and functionalities associated with the RLC layer and its lower layers may be included in the 4G-DU. Note that the data rate of the CPRI may be decreased due to the CU-DU division.

Note that multiple 5G-DUs may be coupled to the 5G-CU. Also, NR-DC (NR-NR Dual Connectivity) may be performed by coupling a UE to the multiple 5G-DUs, or the NR-DC may be performed by coupling the UE to the multiple 5G-DUs and the single 5G-CU. Note that the 5G-CU may be coupled to the RPC directly without going through the 4G-CU, or the 4G-CU may be coupled to the 5GC directly without going through the 5G-CU.

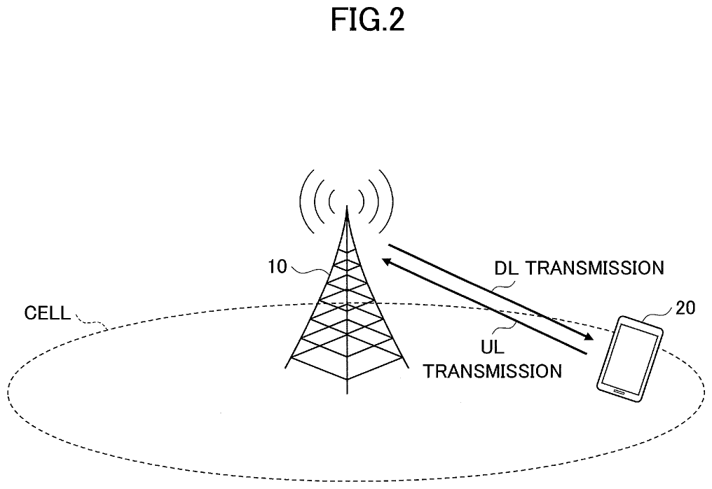

FIG. 2 is a diagram illustrating an arrangement example of a radio communication system according to an embodiment of the present invention. As illustrated in FIG. 2, the radio communication system according to the embodiment of the present invention includes the base station 10 and the terminal 20. In FIG. 2, the single base station 10 and the single terminal 20 are illustrated, but the illustrated embodiment is merely one example, and a plurality of the base stations 10 and a plurality of the terminals 20 may be provided.

The base station 10 is a communication device that serves one or more cells and wirelessly communicates to the terminal 20. A physical resource for a radio signal is defined with a time domain and a frequency domain. The time domain may be defined with the number of OFDM symbols, and the frequency domain may be defined with the number of subcarriers or the number of resource blocks. The base station 10 transmits a synchronization signal and system information to the terminal 20. The synchronization signal may be an NR-PSS and an NR-SSS, for example. The system information may be transmitted in an NR-PBCH, for example, and may be also referred to as broadcast information. As illustrated in FIG. 2, the base station 10 transmits a control signal or data to the terminal 20 in downlinks (DLs) and receives a control signal or data from the terminal 20 in uplinks (ULs). Any of the base station 10 and the terminal 20 can perform beamforming to transmit and receive signals. Also, any of the base station 10 and the terminal 20 can perform beamforming for transmitting and receiving signals. Also, any of the base station 10 and the terminal 20 can apply MIMO (Multiple Input Multiple Output) communication to the DLs and ULs. Also, any of the base station 10 and the terminal 20 may communicate via a SCell (Secondary Cell) and a PCell (Primary Cell) in CA (Carrier Aggregation).

The terminal 20 is a communication device having a radio communication function such as a smartphone, a portable telephone, a tablet, a wearable terminal, a M2M (Machine-to-Machine) communication module or the like. As illustrated in FIG. 2, the terminal 20 receives a control signal or data from the base station 10 in DLs and transmits a control signal or data to the base station 10 in ULs to use various communication services provided by the radio communication system.

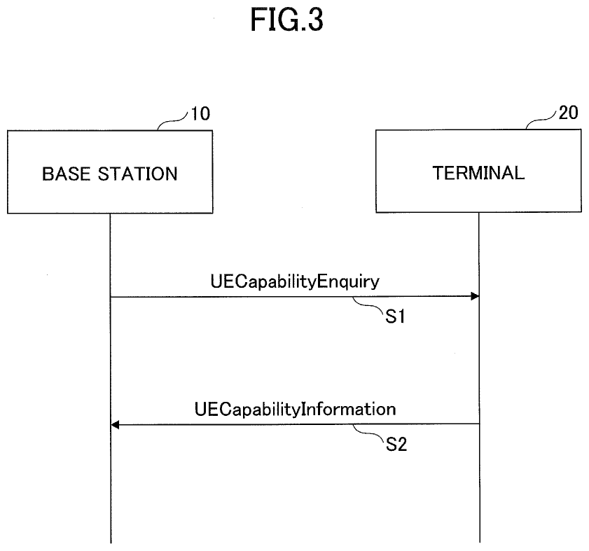

FIG. 3 is a sequence diagram illustrating a terminal capability report example according to an embodiment of the present invention. At step S1 illustrated in FIG. 3, the base station 10 transmits a “UECapabilityEnquiry”, that is, an enquiry for a UE capability, to the terminal 20. At the subsequent step S2, the terminal 20 transmits “UECapabilityInformation” for the UE capability indicated by the received “UECapabilityEnquiry”, that is, a report of the UE capability, to the base station 10. The “UECapabilityInformation” includes the UE capability supported by the terminal 20. The base station 10 identifies the supported UE capability based on the received “UECapabilityInformation” and applies it to radio communication with the terminal 20.

A HighPowerUE (referred to as a “HPUE” hereinafter) with a UE capability of single band (LTE-TDD band or NR-TDD band) or intra-band EN-DC (TDD band) is defined. The HPUE is classified into Power class 2, and the maximum transmit power is 26 dBm. The HPUE may be defined in inter-band EN-DC. Note that Power class 1 having the maximum transmit power 31 dBm is defined. Table 1 is an example of Power class 2 being defined in the inter-band EN-DC.

TABLE 1

| | Power class 2 | Tolerance | Power class 3 | Tolerance |
|---|---|---|---|---|
| EN-DC configuration | (dBm) | (dB) | (dBm) | (dB) |
| DC_1A_n3A | | | 23 | +2/−3 |
| DC_1A_n5A | | | 23 | +2/−3 |
| DC_1A_n7A | | | 23 | +2/−3 |
| DC_1A_n28A | | | 23 | +2/−3 |
| DC_1A_n38A | | | 23 | +2/−3 |
| DC_1A_n40A | | | 23 | +2/−3 |
| DC_1A_n51A | | | 23 | +2/−3 |
| DC_1A_n77A | | | 23 | +2/−3 |
| DC_1 A_n84A_ULSUP-TDM_n77A | | | | |
| DC_1 A_n84A_ULSUP-FDM_n77A | | | | |
| DC_1A_n78A | | | 23 | +2/−3 |
| DC_1 A_n84A_ULSUP-TDM_n78A | | | | |
| DC_1 A_n84A_ULSUP-FDM_n78A | | | | |
| : | : | : | : | : |
| DC_3A_n51A | | | 23 | +2/−3 |
| DC_3A_n77A | | | 23 | +2/−3 |
| DC_3A_n80A_ULSUP-TDM_n77A | | | | |
| DC_3A_n80A_ULSUP-FDM_n77A | | | | |
| DC_3A_n78A | 26 | +2/−3 | 23 | +2/−3 |
| DC_3A_n80A_ULSUP-TDM_n78A, | | | | |
| DC_3A_n80A_ULSUP-FDM_n78A | | | | |
| DC_3A_n79A | | | 23 | +2/−3 |
| DC_3C_n79A | | | | |
| DC_3A_n80A_ULSUP-TDM_n79A, | | | | |
| DC_3A_n80A_ULSUP-FDM_n79A | | | | |
| DC_3A_n82A | | | 23 | +2/−3 |
| : | : | : | : | : |

Table 1 illustrates an example where Power class 2, the maximum transmit power 26 dBm and tolerance+2/−3 dB are configured in inter-band DC_3A_n78A, inter-band DC_3A_n80A_ULSUP (Uplink Sharing from UE Perspective) TDM_n78A and inter-band DC_3A_n80_A_ULSUP_FDM_n78A. In Table 1, any band is included in FR1 (Frequency Range 1), but the LTE-FDD band may be FR1 and the NR-TDD band may be FR2.

In the single band or the EN-DC, the terminal 20 has reported the duty cycle allowing for transmission at the maximum transmit power 26 dBm as the UE capability to a network in consideration of problems such as a SAR (Specific Absorption Rate) or heating of the terminal. For example, the duty cycle allowing for transmission at the maximum transmit power 26 dBm per band is reported in the case of the single band, and the duty cycle allowing for transmission at the maximum transmit power 26 dBm per band combination is reported in the case of the EN-DC.

For example, if the duty cycle of transmission at 26 dBm is 50%, the averaged transmit power in a certain period can be considered as Power class 3 (23 dBm).

The network performs scheduling in consideration of the duty cycle of the reported UE capability in an environment where 26 dBm is required for the transmit power of the terminal 20. On the other hand, for the terminal 20 close to a base station, the terminal 20 can communicate at a relatively small transmit power, and the transmit power of 26 dBm is not necessary. Accordingly, the network may perform scheduling at the duty cycle exceeding the reported UE capability.

Here, because it is assumed that for the HPUE in the EN-DC of the LTE-TDD band+the NR-TDD band, any of the TDD bands is conventionally used at a relatively close frequency and the degree of influence of inter-band SAR or the like is relatively similar, the UE capability associated with the duty cycle per band combination referred to as maxUplinkDutyCycle-EN-DC is stipulated. However, in the NR system, the difference of frequencies for the FDD band and the TDD band or the TDD band and the TDD band may be in some cases relatively large, and the degree of influence over the SAR or the heating of the terminal in each band may differ.

Also, if the dual connectivity is applied between different RATs (Radio Access Technologies), the respective maximum transmit power configured for the RATs may not be equal. For example, it is considered that in the case of the EN-DC of the LTE-TDD+the NR-TDD or the LTE-FDD+the NR-TDD, the total maximum transmit power may be 26 dBm while the maximum transmit power for the respective bands can be 26 dBm. In other words, the capability of the terminal 20 in the case of the total maximum transmit power being 26 dBm may not be stipulated as the upper limit of the transmit power per band of LTE 23 dBm and NR 23 dBm.

Also, a network can indicate the upper limit value of transmit power for each band (which may be referred to as “maximum transmit power”) via parameter P_{LTE} or P_{NR}. For example, if the terminal 20 supports the EN-DC of Power class 2 and bands of the respective RATs composing the DC support Power class 2, it may be considered that the network configures different upper limit values of transmit power such as P_{LTE}=24 dBm and P_{NR}=20 dBm. Considering the allocation where the upper limits of power for respective bands are not equal, the duty cycles of the respective RATs must be determined.

In the assumption, the HPUE must configure the transmit power appropriately based on the duty cycle allowing for transmission at the maximum transmit power. Then, the duty cycles for the respective RATs are defined in schemes illustrated in 1) and 2) below.

UplinkDutyCycle_{LTE}*(p_{LTE}/p_{PowerClass,EN-DC})*Ratio_{effect}+UplinkDutyCycle_{NR}*(p_{NR}/p_{PowerClass,EN-DC})≤maxUplinkDutyCycle 1)

In the above formula, the UplinkDutyCycle_{LTE} is the uplink transmission duty cycle for the LTE. The UplinkDutyCycle_{NR} is the uplink transmission duty cycle. The p_{LTE} is a linear value of the upper limit value of transmit power allowed in the LTE network. The p_{PowerClass}, EN-DC is the power class in the EN-DC and corresponds to the linear value of transmit power 26 dBm for Power class 2. The p_{NR} is the linear value of the upper limit value of transmit power allowed in the NR network. The p_{LTE} and p_{NR} are allowable maximum power indicated from the network to the terminal 20. The Ratio_{effect} is the ratio indicative of the degree of influence of the LTE over the reference degree of influence of the NR. The degree of influence is the degree of influence over the SAR and heating of the terminal 20, for example. The maxUplinkDutyCycle is the UL transmission duty cycle at NR standalone as the UE capability. Note that the Ratio_{effect} may be “1” as a default value if it is not indicated from the terminal 20, for example.

As stated above, if a band of the NR side is supported for the HPUE in a case of standalone, the maxUplinkDutyCycle may be used to define the upper limit of the duty cycle of the LTE and the NR. The new UE capability is only the Ratio_{effect}, and increase in signaling is restrained. If it is assumed that the LTE and the NR have the same degree of influence, Ratio_{effect} can be configured as Ratio_{effect}=1. If the Ratio_{effect} is not indicated, the default value 1 is configured. Note that if carrier aggregation is applied instead of dual connectivity, the LTE, the NR and the power class in the EN-DC may be replaced with a first carrier, a second carrier and the power class in the CA in the above formula.

UplinkDutyCycle_{LTE}*(p_{LTE}/p_{PowerClass,EN-DC})*Ratio_{SAR}+UplinkDutyCycle_{NR}*(p_{NR}/p_{PowerClass,EN-DC})≤maxUplinkDutyCycle-EN-DC

In the formula illustrated in 2), the maxUplinkDutyCycle in 1) is replaced with the maxUplinkDutyCycle-EN-DC for indicating the optimal UL transmission duty cycle per band combination as the EN-DC.

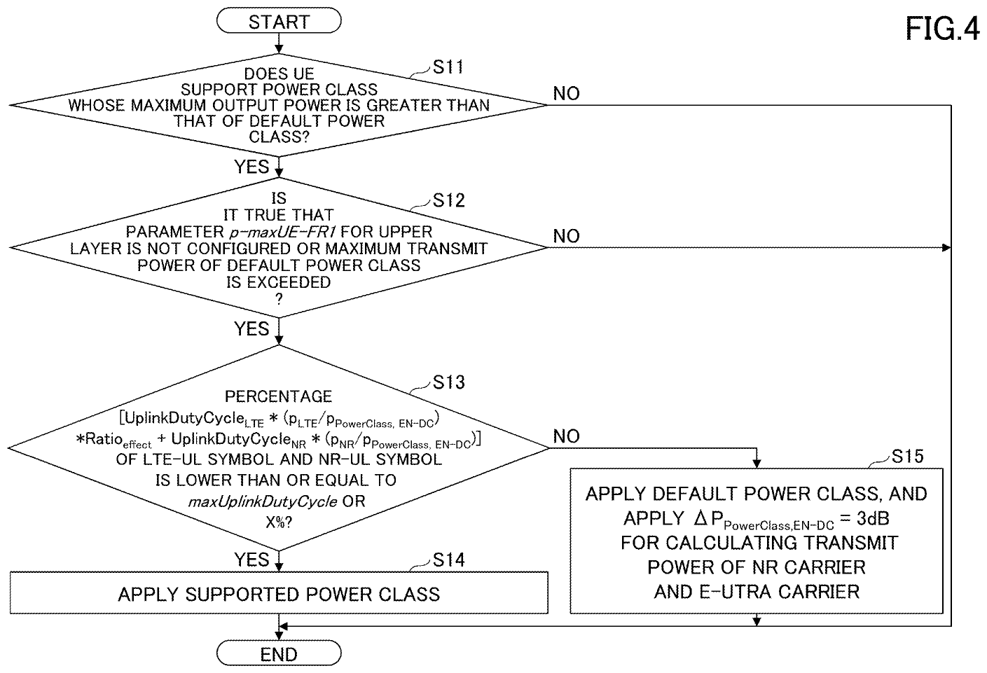

FIG. 4 is a flowchart illustrating a configuration example of an applied power class according to an embodiment of the present invention. An operation for the terminal 20 to configure a power class in inter-band EN-DC is described with reference to FIG. 4.

At step S11, the terminal 20 determines whether to support a power class having a larger maximum output power than the default power class. If the terminal 20 supports that power class (YES at S11), the flow proceeds to step S12, and if the terminal 20 does not support the power class (NO at S11), the terminal 20 may apply the default power class.

At step S12, the terminal 20 determines whether the parameter p-maxUE-FR1 for an upper layer is not configured or whether to exceed the maximum transmit power of the default power class. If the parameter p-maxUE-FR1 for an upper layer is not configured or the maximum transmit power of the default power class is exceeded (YES at S12), the flow proceeds to step S13, and if the parameter p-maxUE-FR1 for an upper layer is configured and the maximum transmit power of the default power class is not exceeded (NO at S12), the flow ends.

At step S13, the terminal 20 determines whether the percentage of the LTE-UL symbol and the NR-UL symbol [UplinkDutyCycle_{LTE}*(p_{LTE}/p_{PowerClass, EN-DC})*Ratio_{effect}+UplinkDutyCycle_{NR}*(p_{NR}/p_{PowerClass, EN-DC})] is smaller than or equal to the maxUplinkDutyCycle or X %.

The UplinkDutyCycle_{LTE} used at step S13 is the UL transmission duty cycle for the LTE. The UplinkDutyCycle_{NR} is the UL transmission duty cycle for the NR. The p_{LTE} is the linear value of the upper limit value of transmit power for the LTE. The p_{PowerClass, EN-DC} corresponds to the linear value of the maximum transmit power for Power class 2 in the EN-DC. The p_{NR} is the linear value of the upper limit value of the transmit power for the NR. The Ratio_{effect} is the ratio of the degree of influence of the LTE over the reference degree of influence of the NR.

The maxUplinkDutyCycle is a UE capability of the NR-standalone-based UL transmission duty cycle. The X % is a threshold used in the case where the maxUplinkDutyCycle is not configured. Also, the maxUplinkDutyCycle may be replaced with the maxUplinkDutyCycle-EN-DC. The maxUplinkDutyCycle-EN-DC is the optimal UL transmission duty cycle as the EN-DC indicated per band combination.

The terminal 20 determines whether the percentage of the LTE-UL symbol and the NR-UL symbol is lower than or equal to the maxUplinkDutyCycle or the X %. If the percentage of the LTE-UL symbol and the NR-UL symbol exceeds the maxUplinkDutyCycle or the X % (NO at S13), the flow proceeds to step S15, and if the percentage of the LTE-UL symbol and the NR-UL symbol does not exceed the maxUplinkDutyCycle or the X % (YES at S13), the flow proceeds to step S14.

At step S14, the terminal 20 applies the supported power class and ends the flow. On the other hand, at step S15, the terminal 20 applies the default power class and applies 3 dB to parameter A P_{PowerClass, EN-DC} used to calculate the transmit power for the NR carrier and the E-UTRA carrier to end the flow. The ΔP_{PowerClass}, EN-DC is a value subtracted from P_{PowerClass, EN-DC} when calculating the maximum transmit power.

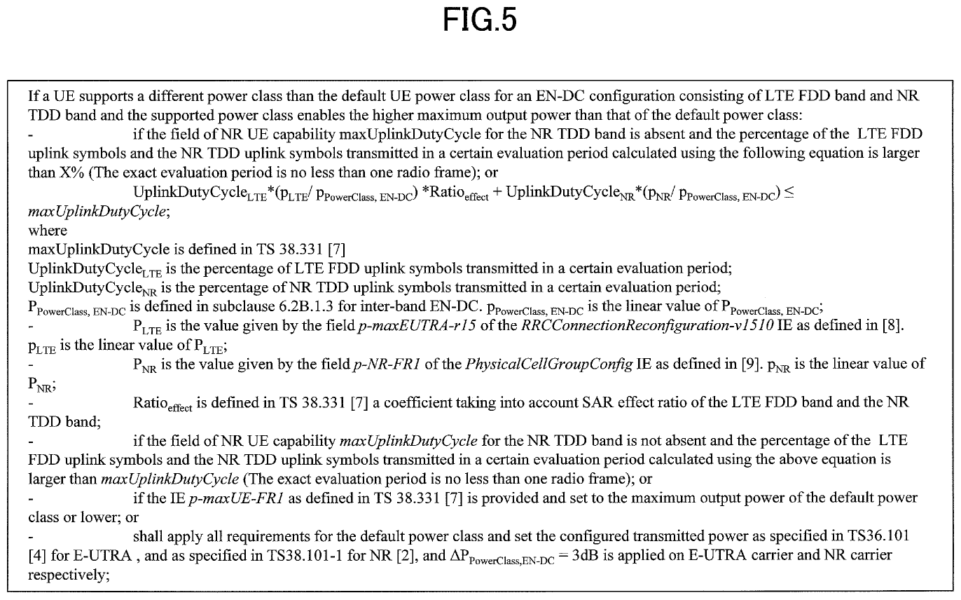

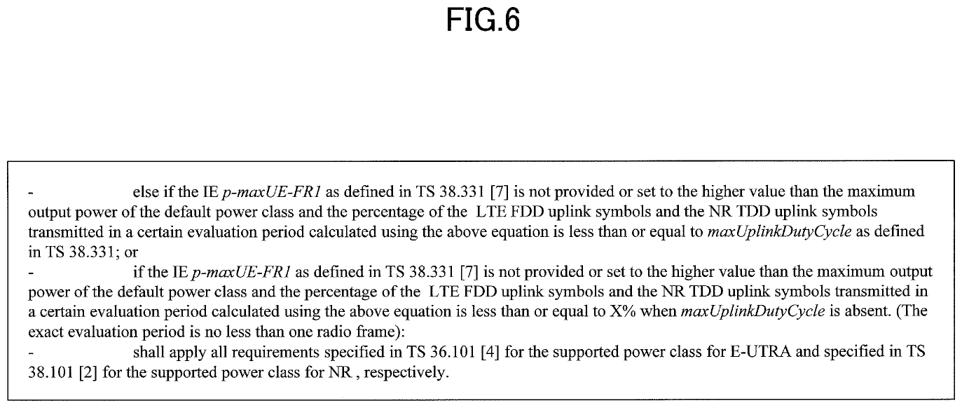

FIG. 5 is a diagram illustrating a specification change example (1) for a power class according to an embodiment of the present invention. FIG. 6 is a diagram illustrating a specification change example (2) for a power class according to an embodiment of the present invention. FIGS. 5 and 6 are specification change examples that recite operations for configuring the power class illustrated in FIG. 4. As illustrated in FIG. 5, the terminal 20 applies the default power class. As illustrated in FIG. 6, the terminal 20 applies the power class having a larger maximum output power than the default power class. The maxUplinkDutyCycle is the UL transmission duty cycle at the NR standalone as the UE capability.

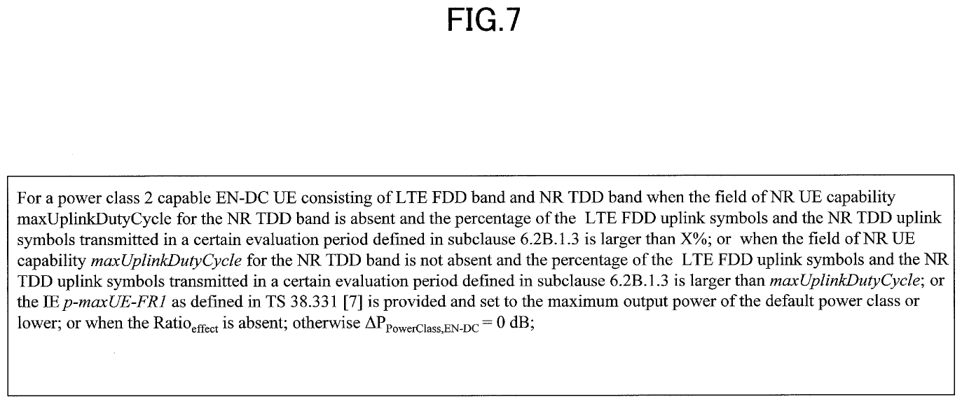

FIG. 7 is a diagram illustrating a specification change example (3) for a power class according to an embodiment of the present invention. In the condition as illustrated in FIG. 7, the terminal 20 having the UE capability of EN-DC Power class 2 may configure ΔP_{PowerClass, EN-DC}=0 dB.

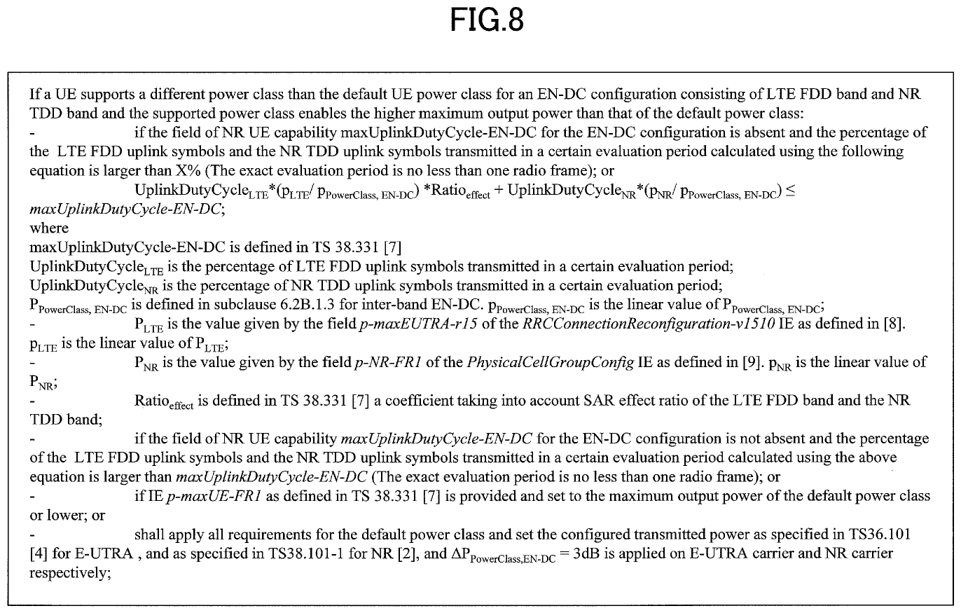

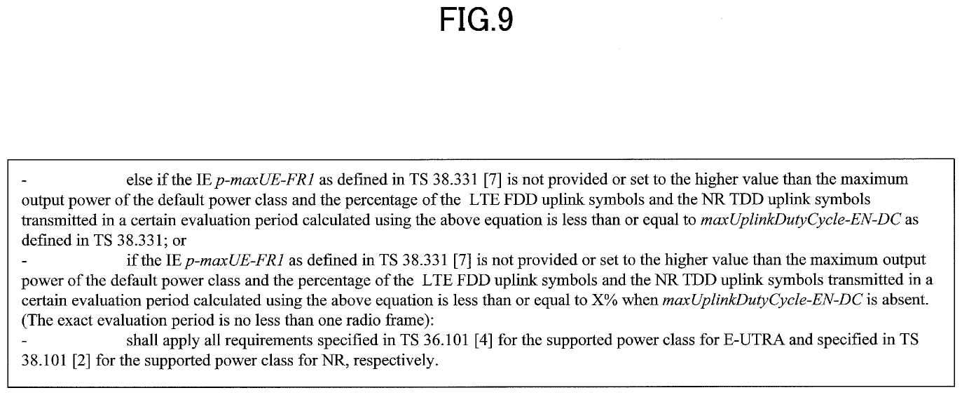

FIG. 8 is a diagram illustrating a specification change example (4) for a power class according to an embodiment of the present invention. FIG. 9 is a diagram illustrating a specification change example (5) for a power class according to an embodiment of the present invention. FIGS. 5 and 6 are specification change examples that recite operations for configuring the power class illustrated in FIG. 4. As illustrated in FIG. 5, the terminal 20 applies the default power class. As illustrated in FIG. 6, the terminal 20 applies a power class having a larger maximum output power than the default power class. The maxUplinkDutyCycle-EN-DC is the optimal UL transmission duty cycle as the EN-DC indicated per band combination.

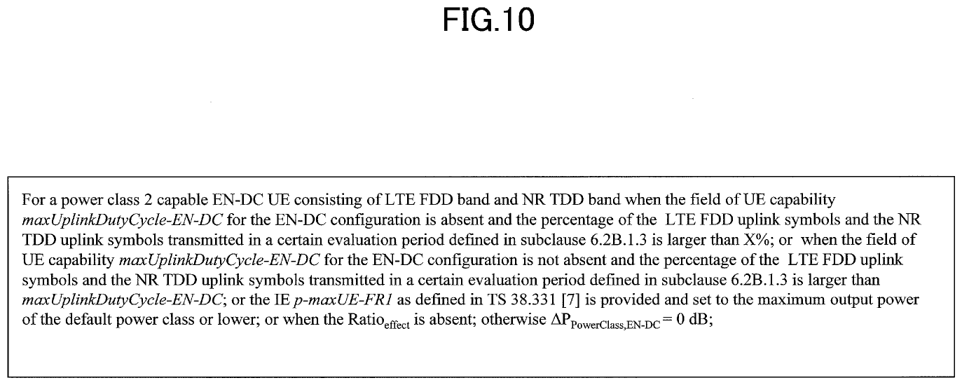

FIG. 10 is a diagram illustrating a specification change example (6) for a power class according to an embodiment of the present invention. In the condition as illustrated in FIG. 10, the terminal 20 having the UE capability of EN-DC Power class 2 configures ΔP_{PowerClass, EN-DC}=0 dB.

The operations associated with configuration of Power class 2 for the dual connectivity as stated above can be applied regardless of the RAT, the FDD, the TDD or the power class.

For example, the above-stated operations associated with configuration of the power class for the dual connectivity can be applied to the LTE-CA regardless of inter-band CA or intra-band CA. They can be applied to CA of LTE-FDD+LTE-FDD, LTE-FDD+LTE-TDD or LTE-TDD+LTE-TDD. Also, they can be applied to the NR-CA regardless of inter-band or intra-band. They can be applied to the CA for NR-FDD+NR-FDD, NR-FDD+NR-TDD or NR-TDD+NR-TDD.

Also, for example, the operations associated with configuration of Power class 2 for the dual connectivity as stated above can be applied to the LTE-DC regardless of inter-band or intra-band. They can be applied to the DC of LTE-FDD+LTE-FDD, LTE-FDD+LTE-TDD or LTE-TDD+LTE-TDD. Also, they can be applied to the NR-DC regardless of inter-band or intra-band. They can be applied to the DC of NR-FDD+NR-FDD, NR-FDD+NR-TDD or NR-TDD+NR-TDD. Also, they can be applied to the DC of LTE+NR regardless of inter-band or intra-band. They can be applied to the DC of LTE-FDD+NR-FDD, LTE-FDD+NR-TDD, LTE-TDD+MR-TDD or LTE-TDD+NR-FDD.

For example, the operations associated with configuration of Power class 2 of the dual connectivity as stated above can be applied to Power class x (29 dBm) as the power class.

For example, the operations associated with configuration of Power class 2 of the dual connectivity as stated above may be applied as Ratio_{effect}=1 in LTE-TDD+NR-TDD. In this manner, if influence between bands of respective RATs are equivalent, the power class can be configured.

According to the above-stated embodiments, if the terminal 20 supports, as the UE capability, Power class 2 of HPUE, the transmit power can be controlled in consideration of the influence of the SAR or heating through duty-cycle-based control in dual-connectivity-applied communication. Also, when the power is allocated with bands or RATs, the terminal 20 can control the transmit power supporting Power class 2 through control based on the duty cycle.

In other words, the transmit power controlled with the duty cycle can be appropriately configured in a radio communication system.

(Device Arrangement)

Next, functional arrangement examples of the base station 10 and the terminal 20 that perform operations and actions as stated above are described. The base station 10 and the terminal 20 include functions of implementing the above-stated embodiments. Note that the base station 10 and the terminal 20 each may have only a portion of the functions of the embodiments.

<Base Station 10>

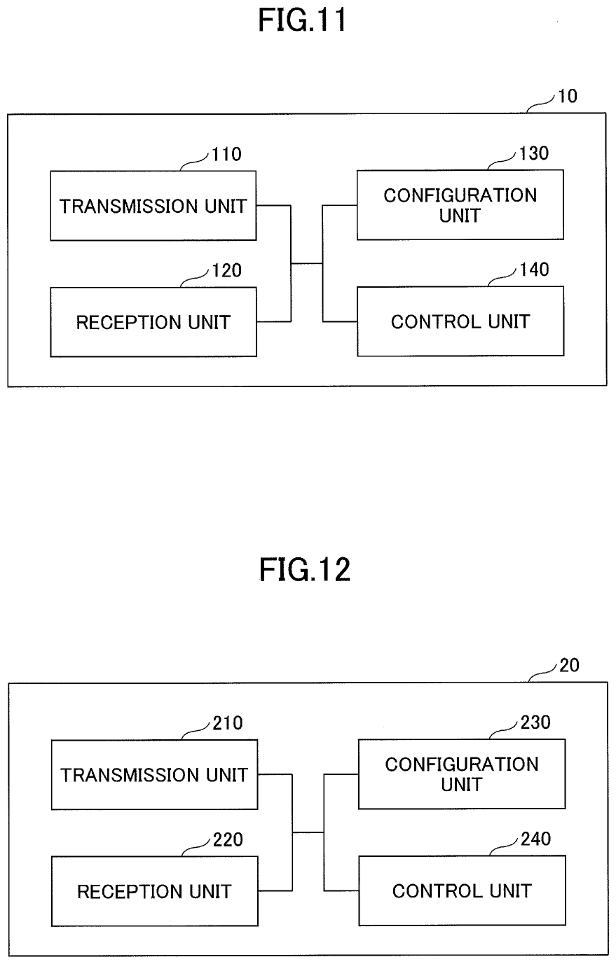

FIG. 11 illustrates afunctional arrangement example of the base station 10. As shown in FIG. 11, the base station 10 includes a transmission unit 110, a reception unit 120, a configuration unit 130 and a control unit 140. The functional arrangement shown in FIG. 11 is only one example. The functional separation and the names of the functional units may be arbitrary as long as operations according to the present embodiment can be achieved.

The transmission unit 110 includes a function of generating a signal to be transmitted to the terminal 20 and wirelessly transmitting the signal to the terminal 20. Also, the transmission unit 110 transmits inter-network-node messages to other network nodes. The reception unit 120 includes a function of receiving various signals transmitted from the terminal 20 and acquiring information for upper layers from the received signals, for example. Also, the transmission unit 110 includes a function of transmitting an NR-PSS, an NR-SSS, an NR-PBCH, a DL/UL control signal or the like to the terminal 20. Also, the reception unit 120 receives inter-network-node messages from other network nodes.

The configuration unit 130 stores preconfigured configurations and various configurations for transmission to the terminal 20. Contents of the configurations may be information associated with transmission and reception configurations corresponding to the UE capability of the terminal 20 or the like, for example.

The control unit 140 performs control associated with processing associated with reporting the UE capability for a radio parameter received from the terminal 20 as stated in conjunction with the embodiments. Also, the control unit 140 controls communication with the terminal 20 based on the UE capability report regarding the radio parameter received from the terminal 20. The functional portions of the control unit 140 related to signal transmission may be included in the transmission unit 110, and the functional portions of the control unit 140 related to signal reception may be included in the reception unit 120.

<Terminal 20>

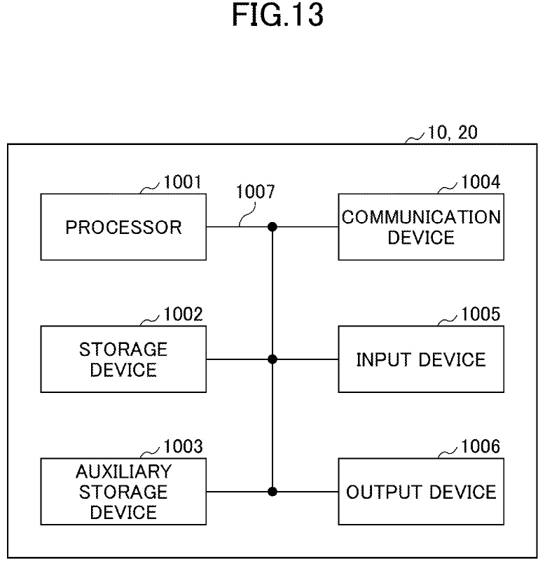

FIG. 12 is a diagram illustrating a functional arrangement example of the terminal 20 according to an embodiment of the present invention. As illustrated in FIG. 12, the terminal 20 has a transmission unit 210, a reception unit 220, a configuration unit 230 and a control unit 240. The functional arrangement shown in FIG. 12 is only one example. The functional separation and the names of the functional units may be arbitrary as long as operations according to the present embodiment can be achieved.

The transmission unit 210 generates a transmission signal from transmission data and wirelessly transmits the transmission signal. The reception unit 220 wirelessly receives various signals and acquires signals for upper layers from the received physical layer signals. Also, the reception unit 220 has a function of receiving an NR-PSS, an NR-SSS, an NR-PBCH, a DL/UL/SL control signal and so on transmitted from the base station 10. Also, for example, as D2D communication, the transmission unit 210 transmits a PSCCH (Physical Sidelink Control Channel), a PSSCH (Physical Sidelink Shared Channel), a PSDCH (Physical Sidelink Discovery Channel), a PSBCH (Physical Sidelink Broadcast Channel) or the like to other terminals 20, and the reception unit 120 receives the PSCCH, the PSSCH, the PSDCH, the PSBCH or the like from other terminals 20.

The configuration unit 230 stores various configurations received at the reception unit 220 from the base station 10. Also, the configuration unit 230 stores preconfigured configurations. Contents of the configurations may be information associated with transmit power configurations corresponding to the UE capability and so on, for example.

The control unit 240 performs control associated with reporting the UE capability regarding a radio parameter for the terminal 20 as stated above. Also, the control unit 240 controls the transmit power corresponding to the UE capability. The functional portion of the control unit 240 regarding signal transmission may be included in the transmission unit 210, and the functional portion of the control unit 240 regarding signal reception may be included in the reception unit 220.

(Hardware Arrangement)

The block diagrams (FIGS. 11 and 12) used for the description of the above embodiments show blocks of functional units. These functional blocks (components) are implemented by any combination of at least one of hardware and software. In addition, the implementation method of each function block is not particularly limited. That is, each functional block may be implemented using a single device that is physically or logically combined, or may be implemented by directly or indirectly connecting two or more devices that are physically or logically separated (e.g., using wire, radio, etc.) and using these multiple devices. The functional block may be implemented by combining software with the above-described one device or the above-described plurality of devices.

Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, etc. For example, a functional block (component) that functions to transmit is called a transmitting unit or a transmitter. In any case, as described above, the implementation method is not particularly limited.

For example, each of the base station 10, the terminal 20 and so on according to one embodiment of the present invention may function as a computer performing operations for a radio communication method according to this embodiment. FIG. 13 is a diagram illustrating an example of a hardware configuration of the base station 10 and the terminal 20 according to one embodiment of the present disclosure. The base station 10 and the terminal 20 as described above may be physically configured as a computer device including a processor 1001, a memory 1002, a storage 1003, a communication device 1004, an input device 1005, an output device 1006, a bus 1007, etc.

In the following description, the term “device” can be read as a circuit, a device, a unit, etc. The hardware configuration of the base station 10 and the terminal 20 may be configured to include one or more of the respective devices shown in the figure, or may be configured without some devices.

Each function of the base station 10 and the terminal 20 is implemented by loading predetermined software (program) on hardware, such as the processor 1001 and the memory 1002, so that the processor 1001 performs computation and controls communication by the communication device 1004, and at least one of reading and writing of data in the memory 1002 and the storage 1003.

The processor 1001, for example, operates an operating system to control the entire computer. The processor 1001 may be configured with a central processing unit (CPU: Central Processing Unit) including an interface with a peripheral device, a control device, a processing device, a register, etc. For example, the above-stated control units 140 and 240 or the like may be implemented by the processor 1001.

Additionally, the processor 1001 reads a program (program code), a software module, data, etc., from at least one of the storage 1003 and the communication device 1004 to the memory 1002, and executes various processes accordingly. A program that causes a computer to execute at least a part of the operations described in the above-described embodiment may be used. For example, the control unit 140 of the base station 10 shown in FIG. 11 may be implemented by a control program that is stored in the memory 1002 and that is operated by the processor 1001. Also, for example, the control unit 240 of the terminal 20 shown in FIG. 12 may be implemented by a control program that is stored in the memory 1002 and that is operated by the processor 1001. While the various processes described above are described as being executed in one processor 1001, they may be executed simultaneously or sequentially by two or more processors 1001. The processor 1001 may be implemented by one or more chips. The program may be transmitted from a network via a telecommunications line.

The memory 1002 is a computer readable storage medium, and, for example, the memory 1002 may be formed of at least one of a ROM (Read Only Memory), an EPROM (Erasable Programmable ROM), an EEPROM (Electrically Erasable Programmable ROM), a RAM (Random Access Memory), etc. The memory 1002 may be referred to as a register, a cache, a main memory (main storage device), etc. The memory 1002 may store a program (program code), a software module, etc., which can be executed for implementing the radio communication method according to one embodiment of the present disclosure.

The storage 1003 is a computer readable storage medium and may be formed of, for example, at least one of an optical disk, such as a CD-ROM (Compact Disc ROM), a hard disk drive, a flexible disk, an optical magnetic disk (e.g., a compact disk, a digital versatile disk, a Blu-ray (registered trademark) disk, a smart card, a flash memory (e.g., a card, a stick, a key drive), a floppy (registered trademark) disk, a magnetic strip, etc. The storage 1003 may be referred to as an auxiliary storage device. The above-described storage medium may be, for example, a database including at least one of the memory 1002 and the storage 1003, a server, or any other suitable medium.

The communication device 1004 is hardware (transmitting and receiving device) for performing communication between computers through at least one of a wired network and a wireless network, and is also referred to, for example, as a network device, a network controller, a network card, a communication module, etc. The communication device 1004 may be configured to include, for example, a high frequency switch, a duplexer, a filter, a frequency synthesizer, etc., to implement at least one of frequency division duplexing (FDD) and time division duplexing (TDD). For example, a transceiver antenna, an amplification unit, a transceiver unit, a channel interface or the like may be implemented with the communication device 1004. The transceiver unit may have an implementation with the transmission unit and the reception unit that are physically or logically separated.

The input device 1005 is an input device (e.g., a keyboard, a mouse, a microphone, a switch, a button, a sensor, etc.) that receives an external input. The output device 1006 is an output device (e.g., a display, speaker, LED lamp, etc.) that performs output toward outside. The input device 1005 and the output device 1006 may be configured to be integrated (e.g., a touch panel).

Each device, such as processor 1001 and memory 1002, is also connected by the bus 1007 for communicating information. The bus 1007 may be formed of a single bus or may be formed of different buses between devices.

Also, the base station 10 and the terminal 20 may include hardware, such as a microprocessor, a digital signal processor (DSP: Digital Signal Processor), an ASIC (Application Specific Integrated Circuit), a PLD (Programmable Logic Device), and a FPGA (Field Programmable Gate Array), which may implement some or all of each functional block. For example, the processor 1001 may be implemented using at least one of these hardware components.

### Conclusion of the Embodiments

As described above, according to an embodiment of the present invention, there is provided a terminal, comprising: a control unit configured to use, in dual connectivity using a first RAT (Radio Access Technology) and a second RAT, a first power class if a duty cycle is smaller than or equal to a threshold, the duty cycle obtained by adding a value obtained by multiplying a duty cycle for the first RAT, a value obtained by dividing a maximum transmit power allowed for a network of the first RAT by a maximum transmit power for the dual connectivity corresponding to the first power class, and a ratio indicative of a degree of influence of the first RAT over the second RAT as a reference, to a value obtained by multiplying a duty cycle for the second RAT and a value obtained by dividing a maximum transmit power allowed for a network of the second RAT by a maximum transmit power for the dual connectivity corresponding to the first power class; and a transmission unit that performs uplink transmission to which the first power class is applied.

According to the above arrangement, if the terminal 20 supports Power class 2 of the HPUE as the UE capability, the transmit power can be controlled in dual connectivity applied communication in consideration of influence of the SAR or heating by duty-cycle-based control. Also, when the power is allocated with bands or RATs, the terminal 20 allows for the transmit power control supporting Power class 2 by the duty cycle based control. In other words, the transmit power controlled by the duty cycle can be appropriately configured in a radio communication system.

The control unit may use a second power class if the added duty cycle exceeds the threshold, and the transmission unit may perform uplink transmission to which the second power class is applied. According to the arrangement, if the terminal 20 supports Power class 2 of the HPUE as the UE capability, the transmit power can be controlled in dual connectivity applied communication in consideration of the influence of the SAR or heating by the duty cycle based control.

The second power class may have a smaller maximum transmit power than the first power class. According to the arrangement, if the terminal 20 supports Power class 2 of the HPUE as the UE capability, the transmit power can be controlled in dual connectivity applied communication in consideration of the influence of the SAR or heating by the duty cycle based control.

The threshold may be a maximum duty cycle for the second RAT. According to the arrangement, if the terminal 20 supports Power class 2 of the HPUE as the UE capability, the transmit power can be controlled in dual connectivity applied communication in consideration of the influence of the SAR or heating by the duty cycle based control.

The threshold may be a maximum duty cycle for the dual connectivity. According to the arrangement, if the terminal 20 supports Power class 2 of the HPUE as the UE capability, the transmit power can be controlled in dual connectivity applied communication in consideration of the influence of the SAR or heating by the duty cycle based control.

Also, according to an embodiment of the present invention, there is provided a communication method performed by a terminal, the method comprising: using, in dual connectivity using a first RAT (Radio Access Technology) and a second RAT, a first power class if a duty cycle is smaller than or equal to a threshold, the duty cycle obtained by adding a value obtained by multiplying a duty cycle for the first RAT, a value obtained by dividing a maximum transmit power allowed for a network of the first RAT by a maximum transmit power for the dual connectivity corresponding to the first power class, and a ratio indicative of a degree of influence of the first RAT over the second RAT as a reference, to a value obtained by multiplying a duty cycle for the second RAT and a value obtained by dividing a maximum transmit power allowed for a network of the second RAT by a maximum transmit power for the dual connectivity corresponding to the first power class; and performing uplink transmission to which the first power class is applied.

According to the above arrangement, if the terminal 20 supports Power class 2 of the HPUE as the UE capability, the transmit power can be controlled in dual connectivity applied communication in consideration of influence of the SAR or heating by duty cycle based control. Also, when the power is allocated with bands or RATs, the terminal 20 allows for the transmit power control supporting Power class 2 by the duty cycle based control. In other words, the transmit power controlled by the duty cycle can be appropriately configured in a radio communication system.

### Supplemental Embodiments

The embodiment of the present invention has been described above, but the disclosed invention is not limited to the above embodiment, and those skilled in the art would understand that various modified examples, revised examples, alternative examples, substitution examples, and the like can be made. In order to facilitate understanding of the present invention, specific numerical value examples are used for explanation, but the numerical values are merely examples, and any suitable values may be used unless otherwise stated. Classifications of items in the above description are not essential to the present invention, contents described in two or more items may be used in combination if necessary, and contents described in an item may be applied to contents described in another item (unless a contradiction arises). The boundaries between the functional units or the processing units in the functional block diagrams do not necessarily correspond to the boundaries of physical components. Operations of a plurality of functional units may be physically implemented by a single component and an operation of a single functional unit may be physically implemented by a plurality of components. Concerning the processing procedures of the embodiment described above, the orders of steps may be changed unless a contradiction arises. For the sake of convenience in describing the processing, the base station 10 and the terminal 20 have been described using the functional block diagrams, but these apparatuses may be implemented by hardware, software, or a combination thereof. Each of software functioning with a processor of the base station apparatus 10 according to the embodiment of the present invention and software functioning with a processor of the user equipment 20 according to the embodiment of the present invention may be stored in a random access memory (RAM), a flash memory, a read-only memory (ROM), an EPROM, an EEPROM, a register, a hard disk (HDD), a removable disk, a CD-ROM, a database, a server, or any suitable recording media.

Also, the notification of information is not limited to the aspect or embodiment described in the present disclosure, but may be performed by other methods. For example, the notification of information may be performed by physical layer signaling (for example, DCI (Downlink Control Information), UCI (Uplink Control Information)), higher layer signaling (for example, RRC (Radio Resource Control) signaling, MAC (Medium Access Control) signaling, broadcast information (a MIB (Master Information Block) and a SIB (System Information Block)), other signals, or combinations thereof. The RRC signaling may be also be referred to as an RRC message and may be, for example, an RRC connection setup message, an RRC connection reconfiguration message, or the like.

Each aspect and embodiment described in the present disclosure may be applied to at least one of a system that uses a suitable system such as LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (New Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), or Bluetooth (registered trademark), and a next-generation system expanded on the basis thereof. Also, a plurality of systems may be combined and applied (for example, a combination of at least one of LTE and LTE-A with 5G, and the like).

In the operation procedures, sequences, flowcharts, and the like according to each aspect and embodiment described in the present disclosure, the order of steps may be changed unless a contradiction arises. For example, in the methods described in the present disclosure, elements of various steps are illustrated by using an example order and the methods are not limited to the specific order presented.

The specific operations performed by the base station 10 described in the present disclosure may in some cases be performed by an upper node. It is clear that, in a network that includes one or more network nodes including the base station 10, various operations performed for communication with the terminal 20 can be performed by at least one of the base station 10 and another network node other than the base station 10 (for example, a MME, a S-GW, or the like may be mentioned, but not limited thereto). In the above, the description has been made for the case where a network node other than the base station 10 is a single node as an example. However, the network node other than the base station 10 may be a combination of a plurality of other network nodes (for example, an MME and a S-GW).

Information, signals, or the like described in the present disclosure may be output from an upper layer (or a lower layer) to a lower layer (or an upper layer). Information, signals, or the like described in the present disclosure may be input and output via a plurality of network nodes.

Information or the like that has been input or output may be stored at a predetermined location (for example, a memory) and may be managed with the use of a management table. Information or the like that is input or output can be overwritten, updated, or appended. Information or the like that has been output may be deleted. Information or the like that has been input may be transmitted to another apparatus.

In the present disclosure, determination may be made with the use of a value expressed by one bit (0 or 1), may be made with the use of a Boolean value (true or false), and may be made through a comparison of numerical values (for example, a comparison with a predetermined value).

Regardless of whether software is referred to as software, firmware, middleware, microcode, a hardware description language, or another name, software should be interpreted broadly to mean instructions, instruction sets, codes, code segments, program codes, a program, a sub-program, a software module, an application, a software application, a software package, a routine, a subroutine, an object, an executable file, an execution thread, a procedure, a function, and the like.

Also, software, instructions, information, or the like may be transmitted and received through transmission media. For example, in a case where software is transmitted from a website, a server or another remote source through at least one of wired technology (such as a coaxial cable, an optical-fiber cable, a twisted pair, or a digital subscriber line (DSL)) and radio technology (such as infrared or microwaves), at least one of the wired technology and the radio technology is included in the definition of a transmission medium.

Information, signals, and the like described in the present disclosure may be expressed with the use of any one of various different technologies. For example, data, instructions, commands, information, signals, bits, symbols, chips, and the like mentioned herein throughout the above explanation may be expressed by voltages, currents, electromagnetic waves, magnetic fields or magnetic particles, optical fields or photons, or any combinations thereof.

The terms described in the present disclosure and the terms necessary for understanding the present disclosure may be replaced with terms having the same or similar meanings. For example, at least one of a channel and a symbol may be a signal (signaling). A signal may be a message. A component carrier (CC) may be referred to as a carrier frequency, a cell, a frequency carrier, or the like.

The terms “system” and “network” used in the present disclosure are used interchangeably.

Also, information, parameters, and the like described in the present disclosure may be expressed by absolute values, may be expressed by relative values with respect to predetermined values, and may be expressed by corresponding different information. For example, radio resources may be indicated by indices.

The above-described names used for the parameters are not restrictive in any respect. In addition, formulas or the like using these parameters may be different from those explicitly disclosed in the present disclosure. Various channels (for example, a PUCCH, a PDCCH, and the like) and information elements can be identified by any suitable names, and therefore, various names given to these various channels and information elements are not restrictive in any respect.

In the present disclosure, terms such as “base station (BS)”, “radio base station”, “base station apparatus”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like may be used interchangeably. A base station may be referred to as a macro-cell, a small cell, a femtocell, a pico-cell, or the like.

A base station can accommodate one or a plurality of (for example, three) cells. In a case where a base station accommodates a plurality of cells, the whole coverage area of the base station can be divided into a plurality of smaller areas. For each smaller area, a base station subsystem (for example, an indoor miniature base station RRH (Remote Radio Head)) can provide a communication service. The term “cell” or “sector” denotes all or a part of the coverage area of at least one of a base station and a base station subsystem that provides communication services in the coverage.

In the present disclosure, terms such as “mobile station (MS)”, “user terminal”, “user equipment (UE)”, and “terminal” may be used interchangeably.

By the person skilled in the art, a mobile station may be referred to as any one of a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, and other suitable terms.

At least one of a base station and a mobile station may be referred to as a transmitting apparatus, a receiving apparatus, a communication device, or the like. At least one of a base station and a mobile station may be an apparatus mounted on a mobile body, or may be a mobile body itself, or the like. A mobile body may be a transporting device (e.g., a vehicle, an airplane, and the like), an unmanned mobile (e.g., a drone, an automated vehicle, and the like), or a robot (of a manned or unmanned type). It is noted that at least one of a base station and a mobile station includes an apparatus that does not necessarily move during a communication operation. For example, at least one of a base station and a mobile station may be an IoT (Internet of Things) device such as a sensor.

In addition, a base station according to the present disclosure may be read as a user terminal. For example, each aspect or embodiment of the present disclosure may be applied to a configuration in which communication between a base station and a user terminal is replaced by communication between a plurality of user equipments (that may be called D2D (Device-to-Device), V2X (Vehicle-to-Everything), or the like). In this case, a user equipment 20 may have above-described functions of the base station apparatus 10. In this regard, a word such as “up” or “down” may be replaced with a word corresponding to communication between terminals (for example, “side”). For example, an uplink channel, a downlink channel, or the like may be replaced with a side channel.

Similarly, a user terminal according to the present disclosure may be read as a base station. In this case, a base station may have above-described functions of the user terminal.

The term “determine” used herein may mean various operations. For example, judging, calculating, computing, processing, deriving, investigating, looking up, searching, inquiring (for example, looking up a table, a database, or another data structure), ascertaining, or the like may be deemed as making determination. Also, receiving (for example, receiving information), transmitting (for example, transmitting information), inputting, outputting, or accessing (for example, accessing data in a memory), or the like may be deemed as making determination. Also, resolving, selecting, choosing, establishing, comparing, or the like may be deemed as making determination. That is, doing a certain operation may be deemed as making determination. “To determine” may be read as “to assume”, “to expect”, “to consider”, or the like.

Each of the terms “connected” and “coupled” and any variations thereof mean any connection or coupling among two or more elements directly or indirectly and can mean that one or a plurality of intermediate elements are inserted among two or more elements that are “connected” or “coupled” together. Coupling or connecting among elements may be physical one, may be logical one, and may be a combination thereof. For example, “connecting” may be read as “accessing”. In a case where the terms “connected” and “coupled” and any variations thereof are used in the present disclosure, it may be considered that two elements are “connected” or “coupled” together with the use of at least one type of a medium from among one or a plurality of wires, cables, and printed conductive traces, and in addition, as some non-limiting and non-inclusive examples, it may be considered that two elements are “connected” or “coupled” together with the use of electromagnetic energy such as electromagnetic energy having a wavelength of the radio frequency range, the microwave range, or the light range (including both of the visible light range and the invisible light range).

A reference signal can be abbreviated as an RS (Reference Signal). A reference signal may be referred to as a pilot depending on an applied standard.

A term “based on” used in the present disclosure does not mean “based on only” unless otherwise specifically noted. In other words, a term “base on” means both “based on only” and “based on at least”.

Any references to elements denoted by a name including terms such as “first” or “second” used in the present disclosure do not generally limit the amount or the order of these elements. These terms can be used in the present disclosure as a convenient method for distinguishing one or a plurality of elements. Therefore, references to first and second elements do not mean that only the two elements can be employed or that the first element should be, in some way, prior to the second element.

“Means” in each of the above-described apparatuses may be replaced with “unit”, “circuit”, “device”, or the like.

In a case where any one of “include”, “including”, and variations thereof is used in the present disclosure, each of these terms is intended to be open-ended in the same way as the term “comprising”. Further, the term “or” used in the present disclosure is intended to be not exclusive-or.

A radio frame may include, in terms of time domain, one or a plurality of frames. Each of one or a plurality of frames may be referred to as a subframe in terms of time domain. A subframe may include, in terms of time domain, one or a plurality of slots. A subframe may have a fixed time length (e.g., 1 ms) independent of numerology.

The numerology may be a communication parameter that is applied to at least one of transmission or reception of a signal or a channel. The numerology may mean, for example, at least one of a subcarrier spacing (SCS), a bandwidth, a symbol length, a cyclic prefix length, a transmission time interval (TTI), the number of symbols per TTI, a radio frame configuration, a specific filtering processing performed by a transceiver in a frequency domain, a specific windowing processing performed by a transceiver in a time domain, and the like.

A slot may include, in terms of time domain, one or a plurality of symbols (OFDM (Orthogonal Frequency Division Multiplexing) symbols, SC-FDMA (Single Carrier Frequency Division Multiplexing) symbols) symbols, or the like). A slot may be a time unit based on the numerology.

A slot may include a plurality of minislots. Each minislot may include one or a plurality of symbols in terms of the time domain. A minislot may also be referred to as a subslot. A minislot may include fewer symbols than a slot. A PDSCH (or PUSCH) transmitted at a time unit greater than a minislot may be referred to as a PDSCH (or PUSCH) mapping type A. A PDSCH (or PUSCH) transmitted using minislots may be referred to as a PDSCH (or PUSCH) mapping type B.

Each of a radio frame, a subframe, a slot, a minislot, and a symbol refers to a time unit for transmitting a signal. Each of a radio frame, a subframe, a slot, a minislot, and a symbol may be referred to as other names respectively corresponding thereto.

For example, one subframe may be referred to as a transmission time interval (TTI), a plurality of consecutive subframes may be referred to as a TTI, and one slot or one minislot may be referred to as a TTI. That is, at least one of a subframe and a TTI may be a subframe (1 ms) according to the existing LTE, may have a period shorter than 1 ms (e.g., 1 to 13 symbols), and may have a period longer than 1 ms. Instead of subframes, units expressing a TTI may be referred to as slots, minislots, or the like.

A TTI means, for example, a minimum time unit of scheduling in radio communication. For example, in an LTE system, a base station performs scheduling for each user equipment 20 to assign, in TTI units, radio resources (such as frequency bandwidths, transmission power, and the like that can be used by each user equipment 20). However, the definition of a TTI is not limited thereto.

A TTI may be a transmission time unit for channel-coded data packets (transport blocks), code blocks, code words, or the like, and may be a unit of processing such as scheduling, link adaptation, or the like. When a TTI is given, an actual time interval (e.g., the number of symbols) to which transport blocks, code blocks, code words, or the like are mapped may be shorter than the given TTI.

In a case where one slot or one minislot is referred to as a TTI, one or a plurality of TTIs (i.e., one or a plurality of slots or one or a plurality of minislots) may be a minimum time unit of scheduling. The number of slots (the number of minislots) included in the minimum time unit of scheduling may be controlled.

A TTI having a time length of 1 ms may referred to as an ordinary TTI (a TTI according to LTE Rel. 8-12), a normal TTI, a long TTI, an ordinary subframe, a normal subframe, a long subframe, a slot, or the like. A TTI shorter than an ordinary TTI may be referred to as a shortened TTI, a short TTI, a partial or fractional TTI, a shortened subframe, a short subframe, a minislot, a subslot, a slot, or the like.

Note that a long TTI (for example, a normal TTI, a subframe, and the like) may be read as TTI having a time length exceeding 1 ms, and a short TTI (for example, a shortened TTI) may be read as a TTI having a TTI length less than the TTI length of the long TTI and equal to or more than 1 ms.

A resource block (RB) is a resource assignment unit in terms of a time domain and a frequency domain and may include one or a plurality of consecutive subcarriers in terms of frequency domain. The number of subcarriers included in an RB may be the same regardless of the numerology, and, for example, may be 12. The number of subcarriers included in a RB may be determined based on the numerology.

Also, in terms of the time domain, an RB may include one or a plurality of symbols, and may have a length of 1 minislot, 1 subframe, or 1 TTI. Each of 1 TTI, 1 subframe, and the like may include one or a plurality of resource blocks.

One or a plurality of RBs may be referred to as physical resource blocks (PRBs: Physical RBs), a subcarrier group (SCG: Sub-Carrier Group), a resource element group (REG: Resource Element Group), a PRB pair, an RB pair, or the like.

Also, a resource block may include one or a plurality of resource elements (RE: Resource Elements). For example, 1 RE may be a radio resource area of 1 subcarrier and 1 symbol.

A bandwidth part (BWP) (which may be called a partial bandwidth or the like) may mean a subset of consecutive common RBs (common resource blocks) for certain numerology, in any given carrier. A common RB may be identified by a RB index with respect to a common reference point in the carrier. PRBs may be defined by a BWP and may be numbered in the BWP.

A BWP may include a BWP (UL BWP) for UL and a BWP (DL BWP) for DL. For a UE, one or a plurality of BWPs may be set in 1 carrier.

At least one of configured BWPs may be active, and a UE need not assume sending or receiving a predetermined signal or channel outside the active BWP. A “cell”, a “carrier” or the like in the present disclosure may be read as a “BWP”.

The above-described structures of radio frames, subframes, slots, minislots, symbols, and the like are merely examples. For example, the number of subframes included in a radio frame, the number of slots included in a subframe or a radio frame, the number of minislots included in a slot, the number of symbols and the number of RBs included in a slot or a minislot, the number of subcarriers included in an RB, the number of symbols included in a TTI, a symbol length, a cyclic prefix (CP) length, and the like can be variously changed.

Throughout the present disclosure, in a case where an article such as “a”, “an”, or “the” in English is added through a translation, the present disclosure may include a case where a noun following the article is of a plural form.

Throughout the present disclosure, the expression “A and B are different” may mean that “A and B are different from each other”. The expression may also mean that “each of A and B is different from C”. Terms such as “separate” and “coupled” may also be interpreted in a manner similar to “different”.

Each aspect or embodiment described in the present disclosure may be used independently, may be used in combination with another embodiment, and may be used in a manner of being switched with another embodiment upon implementation. Notification of predetermined information (for example, notification of “being x”) may be implemented not only explicitly but also implicitly (for example, by not notifying predetermined information).

In the present disclosure, the LTE is one example of the first RAT. The NR is one example of the second RAT. Power class 2 is one example of the first power class. The default power class is one example of the second power class.

Although an embodiment(s) of the present invention has/have been described above, it will be understood by those skilled in the art that the present disclosure is not limited to the embodiment described in the present disclosure. Modifications and changes of the present disclosure may be possible without departing from the subject matter and the scope of the present disclosure defined by claims. Therefore, the descriptions of the embodiments are for illustrative purposes only, and are not intended to be limiting the present invention in any way.

### LIST OF REFERENCE SYMBOLS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Memory
1003 Storage
1004 Communication device
1005 Input device
1006 Output device

1. A terminal, comprising:
a control unit configured to use, in dual connectivity using a first RAT (Radio Access Technology) and a second RAT, a first power class in a case where a duty cycle is less than or equal to a threshold, the duty cycle obtained by adding
a value obtained by multiplying: a duty cycle for the first RAT; a value obtained by dividing a maximum transmit power allowed for a network of the first RAT by a maximum transmit power for the dual connectivity corresponding to the first power class; and a ratio indicative of a degree of influence of the first RAT over the second RAT as a reference, to
a value obtained by multiplying: a duty cycle for the second RAT; and a value obtained by dividing a maximum transmit power allowed for a network of the second RAT by a maximum transmit power for the dual connectivity corresponding to the first power class; and
a transmission unit configured to perform uplink transmission to which the first power class is applied.

2. The terminal as claimed in claim 1, wherein the control unit uses a second power class in a case where the added duty cycle exceeds the threshold, and the transmission unit performs uplink transmission to which the second power class is applied.

3. The terminal as claimed in claim 2, wherein a maximum transmit power of the second power class is less than a maximum transmit power of the first power class.

4. The terminal as claimed in claim 3, wherein the threshold is a maximum duty cycle for the second RAT.

5. The terminal as claimed in claim 3, wherein the threshold is a maximum duty cycle for the dual connectivity.

6. A communication method performed by a terminal, the method comprising:
using, in dual connectivity using a first RAT (Radio Access Technology) and a second RAT, a first power class in a case where a duty cycle is less than or equal to a threshold, the duty cycle obtained by adding
a value obtained by multiplying: a duty cycle for the first RAT; a value obtained by dividing a maximum transmit power allowed for a network of the first RAT by a maximum transmit power for the dual connectivity corresponding to the first power class; and a ratio indicative of a degree of influence of the first RAT over the second RAT as a reference, to
a value obtained by multiplying: a duty cycle for the second RAT; and a value obtained by dividing a maximum transmit power allowed for a network of the second RAT by a maximum transmit power for the dual connectivity corresponding to the first power class; and
performing uplink transmission to which the first power class is applied.
